(19) United States
(12) Patent Application Publication
(10) Pub. No.: US 2017/0139918 A1
(43) Pub. Date: May 18, 2017

(54) MANAGING IMPORTANCE RATINGS RELATED TO EVENT RECORDS IN A DATABASE SYSTEM

(71) Applicant: salesforce.com, inc., San Francisco, CA (US)

(72) Inventor: Viswanadh Mulukuri, Hyderabad (IN)

(21) Appl. No.: 14/940,945

(22) Filed: Nov. 13, 2015

(51) Int. Cl. G06F 17/30

(52) U.S. Cl. CPC G06F 17/3053; G06F 17/30864; G06F 17/30528

(57) ABSTRACT

Disclosed are examples of systems, apparatus, methods and computer program products for managing importance ratings related to event records in a database system. In some implementations, a server can display a first feed item related to a first event record in a first user interface. User input can be processed via a first interactive graphical representation of an aggregate importance rating. The user input can be incorporated in an update to the aggregate importance rating. An updated aggregate importance rating can be displayed in a second user interface

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to database systems and event records. More specifically, this patent document discloses techniques for managing importance ratings related to event records in a database system.

### BACKGROUND

“Cloud computing” services provide shared resources, applications, and information to computers and other devices upon request. In cloud computing environments, services can be provided by one or more servers accessible over the Internet rather than installing software locally on in-house computer systems. As such, users having a variety of roles can interact with cloud computing services.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 shows a system diagram of an example of a system 100 for managing importance ratings related to event records in a database system, in accordance with some implementations.

FIG. 2 shows a flow chart of an example of a method 200 for managing importance ratings related to event records in a database system, in accordance with some implementations.

FIG. 3 shows an example of a feed as part of a graphical user interface (GUI) 300 as displayed on a computing device, in accordance with some implementations.

FIG. 4 shows an example of a presentation of an event record in the form of a GUI 400 as displayed on a computing device, in accordance with some implementations.

FIGS. 5A-C show other examples of presentations of event records in the form of GUIs 504, 508 and 512 as displayed on a computing device, in accordance with some implementations.

FIGS. 6A-B show examples of team members interacting with an event record, in accordance with some implementations.

FIG. 7A shows a block diagram of an example of an environment 10 in which an on-demand database service can be used in accordance with some implementations.

FIG. 7B shows a block diagram of an example of some implementations of elements of FIG. 7A and various possible interconnections between these elements.

FIG. 8A shows a system diagram of an example of architectural components of an on-demand database service environment 900, in accordance with some implementations.

FIG. 8B shows a system diagram further illustrating an example of architectural components of an on-demand database service environment, in accordance with some implementations.

### DETAILED DESCRIPTION

Examples of systems, apparatus, methods and computer-readable storage media according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some of the disclosed implementations of systems, apparatus, methods and computer program products are configured for managing importance ratings related to event records in a database system.

By way of example, employees in large companies regularly attend informational meetings such as training meetings, continuing education courses, etc. A company may offer many informational meetings on different topics. Generally, only some of the informational meetings are beneficial to a particular employee. Consequently, employees frequently attend informational meetings that are not beneficial to them, wasting employee time and company resources.

By way of illustration, Phil is an industrial designer at Build Big, a furniture company employing thousands of employees worldwide. Per company policy, each year Phil is required to attend five continuing education courses on industrial design. Phil is kept very busy creating the latest and greatest furniture designs. Thus, he has limited time to evaluate the many continuing education courses offered by Build Big. Last year, in a rush Phil mistakenly attended an accounting course and also missed a design course highly recommended by his fellow industrial designers.

However, this year Build Big has implemented some examples of the disclosed techniques for managing importance ratings related to event records in a database system. For example, Build Big is a subscriber to salesforce.com, inc.'s Chatter®, an enterprise social networking system. In some implementations, each continuing education course offered by Build Big has an average score of ratings from previous attendees. In one example, relevant continuing education courses along with their respective average scores can be identified and presented in Phil's news feed provided by Chatter®. Without leaving his news feed, Phil can easily view ratings and comments from members of his design team to gauge his interest in particular continuing education courses. Phil can thus quickly identify and attend more meaningful courses that expand Phil's skill set and add value to Build Big while reducing wasted time and company resources.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

In some but not all implementations, the disclosed methods, apparatus, systems, and computer-readable storage media may be configured or designed for use in a multi-tenant database environment.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

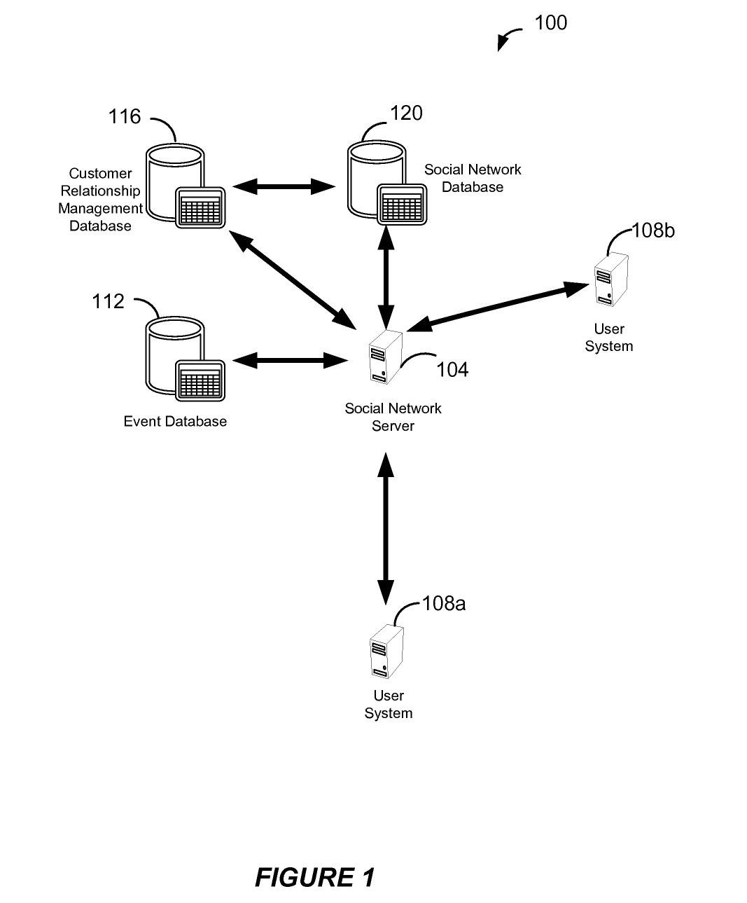

FIG. 1 shows a system diagram of an example of a system 100 for managing importance ratings related to event records in a database system, in accordance with some implementations. System 100 includes a variety of different hardware and/or software components which are in communication with each other. In the non-limiting example of FIG. 1, system 100 includes at least one social network server 104, at least one event database 112, at least one customer relationship management (CRM) database 116, and at least one social network database 120.

Social network server 104 may communicate with other components of system 100. This communication may be facilitated through a combination of networks and interfaces. Social network server 104 may handle and process data requests from user systems 108a and 108b. Likewise, social network server 104 may return a response to user systems 108a and 108b after the data request has been processed. Also or alternatively, social network server 104 may automatically retrieve data from any database of system 100, and send that data to user systems 108a and 108b. For example, social network server 104 may populate a feed with feed items in a user interface displayed to a user of user system 108a. In other implementations, social network server 104 may retrieve data from one or more databases, combine some or all of the data from different databases, and send processed data including a feed item for a meeting with an importance rating to user system 108a or 108b.

Event database 112 can be configured to receive, transmit, store, update, and otherwise maintain event data stored in event records of database 112. In some implementations, event records may include some data generated by social network server 104 in response to user input from user system 108a. For example, event database 112 can store an importance rating transmitted from user system 108a and processed by social network server 104. Also or alternatively, event records include data and/or identifiers to data stored in CRM database 116, such as related case records, and data stored in social network database 120 such as related feed items.

In FIG. 1, CRM database 116 can be configured to receive, transmit, store, update, and otherwise maintain CRM data. CRM database 116 can store CRM records specific to one organization in an enterprise system. Examples of CRM records include accounts, opportunities, leads, cases, contacts, contracts, campaigns, solutions, quotes, purchase orders, etc. In some implementations, CRM records are hierarchically arranged in CRM database 116 with some CRM records identifying relationships between and among records stored in CRM database 116, as well as, event database 112 and social network database 120.

Social network database 120 can be configured to cooperate with social network server 104 to implement and manage a social network system including social network feeds, feed items, and associated metadata all stored or identified by social network data in social network database 120. Also or alternatively, social network database 120 can store data identifying teams and team members, discussed further below. In some implementations, a team and the team's respective members are arranged hierarchically with subsets of team members. For example, a team may include five team members. One team member could be a manager and the other four team members could be associates who report to the manager.

User systems 108a and 108b may be computing devices capable of communicating via one or more data networks with a server. Examples of user systems 108a and 108b include a desktop computer or portable electronic device such as a smartphone, a tablet, a laptop, a wearable device such as Google Glass®, another optical head-mounted display (OHMD) device, a smart watch, etc. Also or alternatively, there may be user profiles specific to the users of user systems 108a and 108b. In some implementations, social network server 104 can generate a feed including a feed item related to an event record and cause the feed item and/or the event record to be displayed at both user systems 108a and 108b.

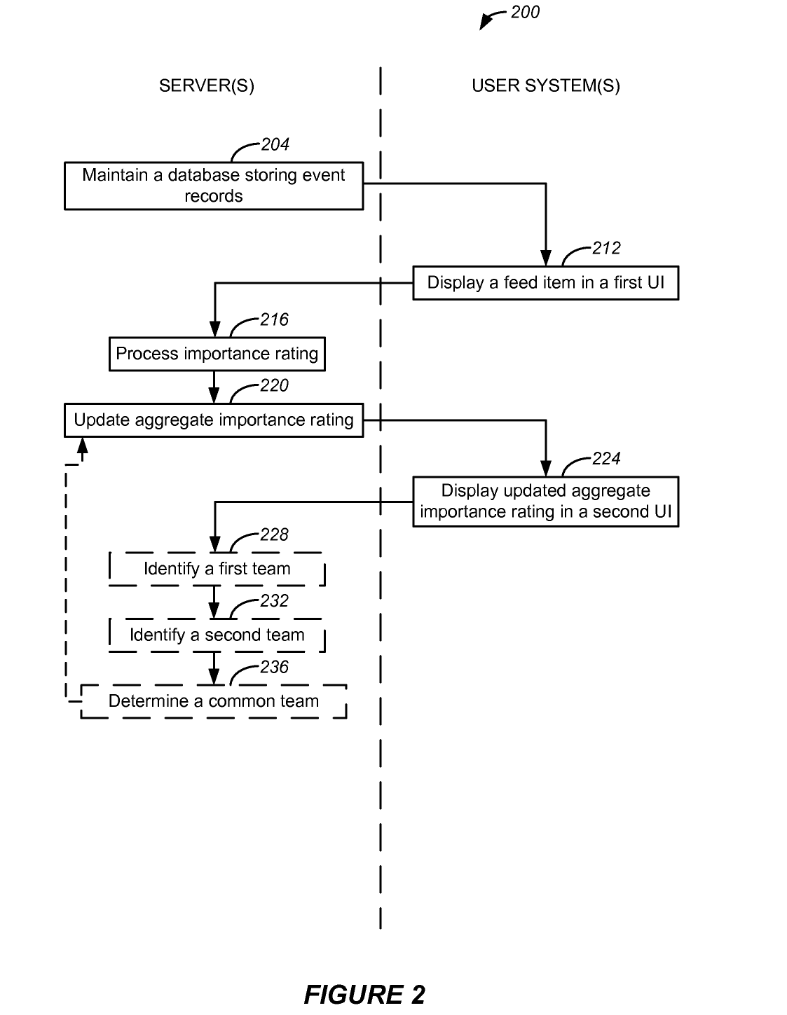

FIG. 2 shows a flow chart of an example of a method 200 for managing importance ratings related to event records in a database system, in accordance with some implementations. Method 200 and other methods described herein may be implemented using system 100 of FIG. 1, although the implementations of such methods are not limited to system 100.

In block 204 of FIG. 2, a database storing event records such as event database 112 of FIG. 1 is maintained as part of a database system. In some implementations, event records store data regarding a meeting or session. In some instances, the meeting is a recurring meeting. For example, a continuing education course can be a meeting at Build Big occurring the first Friday of every month. Also or alternatively, event records store data identifying a topic of a meeting, for instance, “Design Basics 101.” In some implementations, an event record can also store or identify data characterizing an importance rating for meeting. The importance rating can be displayed in a user interface as an indication of the predicted interest a user may have in attending a meeting. For example, Phil may see a 4 out of 5 star rating for “Design Basics 101” in his user interface. Thus, Phil can quickly and easily recognize that he is likely to enjoy attending “Design Basics 101.”

A social networking system is provided in some implementations, as disclosed herein. As described above, a social networking system can include a social network server 104 and a social network database 120. Social network server 104 can be configured to maintain and update feeds that include feed items related to a particular event record. For example, Phil can navigate to a webpage with a feed and view a feed displaying recent updates such as new comments regarding “Design Basics 101.” Additional details of social networking systems are further described below.

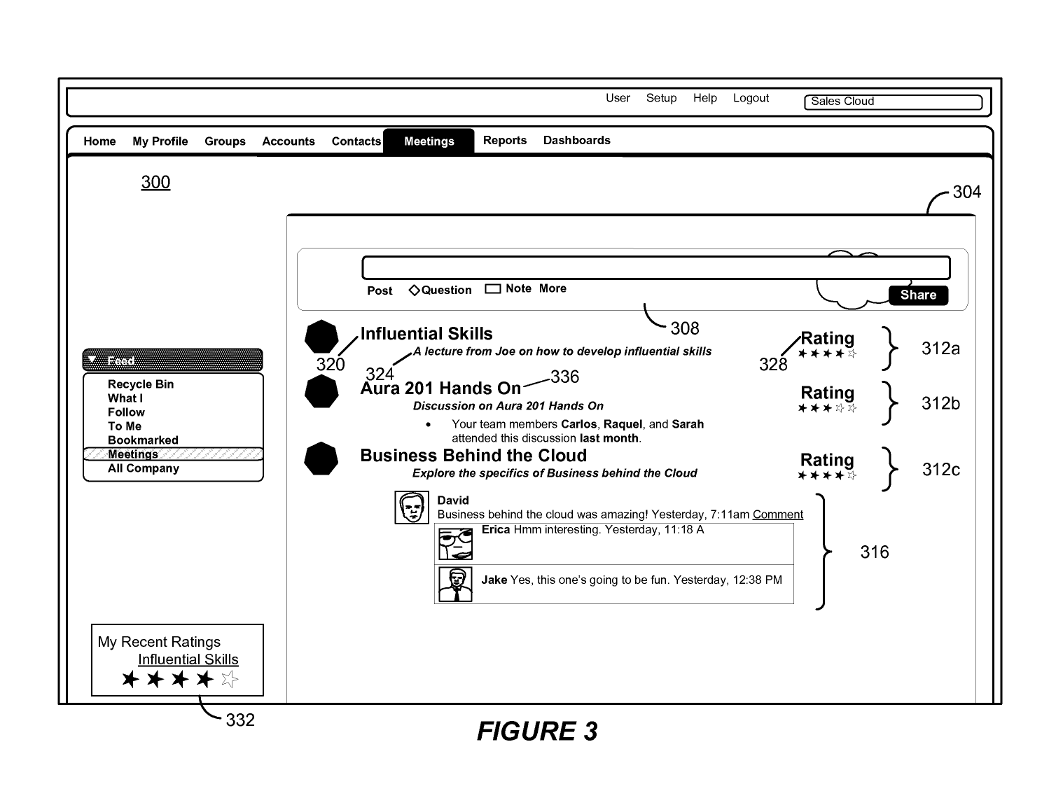

In block 212 of FIG. 2, a feed item is displayed in a user interface of a user device such as user system 108a of FIG. 1. For example, FIG. 3 shows an example of a feed as part of a graphical user interface (GUI) 300 as displayed on a computing device, in accordance with some implementations. In FIG. 3, user interface 300 includes a publisher 308 and feed items 312a, 312b, and 312c displayed in feed 304. Feed item 312c includes a thread of comments 316. In one example, Lupito, the user viewing user interface 300, may select a “Comment” hyperlink and write a comment to “David” asking, “Why was ‘Business Behind the Cloud’ so amazing?” As such, a user can receive quick feedback without navigating away from feed 304. In some implementations, Lupito can quickly look at feed items 312a, 312b, and 312c to gauge his interest in a particular meeting. For example, towards the top of feed 304, Lupito sees “Influential Skills” as a meeting title 320 of feed item 312a. In some implementations, meeting title 320 is a hyperlink to a webpage dedicated to the meeting. In some implementations, a user can click meeting title 320 to view more details about a meeting.

In the non-limiting example of FIG. 3, feed item 312b is associated with a related event record. In some implementations, social network server 104 of FIG. 1 can display related meeting 336 of FIG. 3 based on Lupito's team members previously attending the same meeting. In this example, feed 304 shows a bullet point indicating “Your team members Carlos, Raquel, and Sarah attended this discussion last month.” In other implementations, social network server 104 of FIG. 1 can display related meeting 336 of FIG. 3 based on Lupito's browsing activity. For example, if Lupito had previously accessed the webpage for “Aura 201 Hands On,” then social network server 104 of FIG. 1 may display related meeting 336 of FIG. 3. In still other implementations, related meeting 336 may be displayed in feed 304 based on “Aura 201 Hands On” being a second part of a series of meetings that Lupito had already attended.

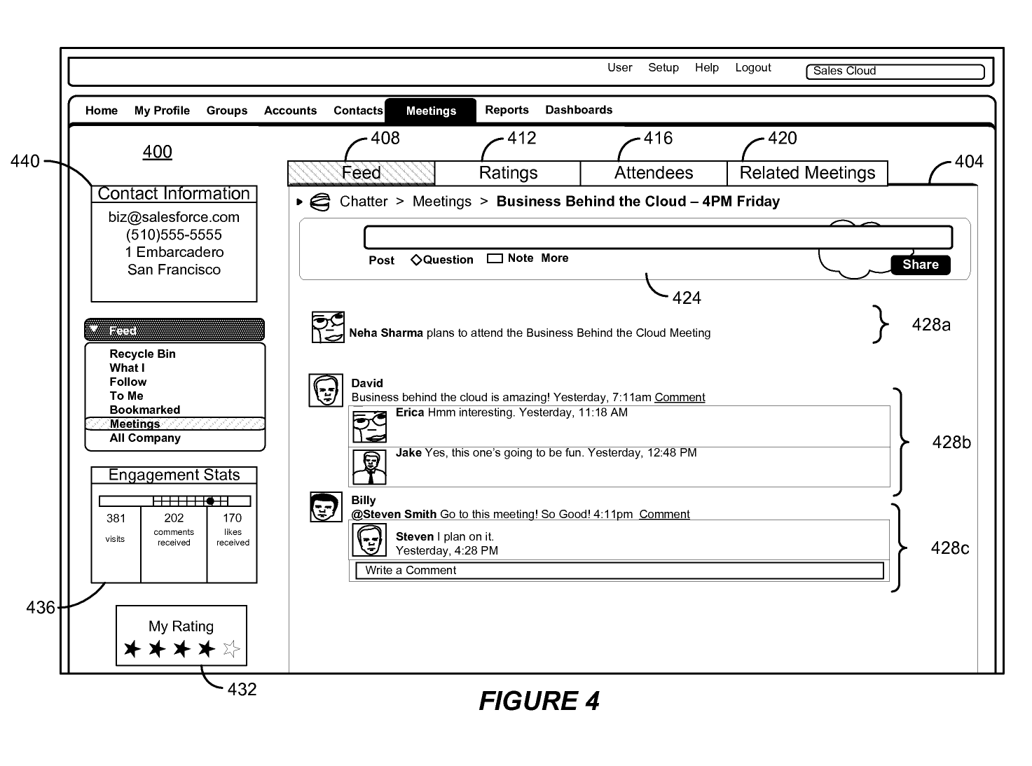

In another non-limiting example, a user clicking meeting title 320 may be presented with contextual details such as a time, location, and list of attendees. FIG. 4 shows an example of a presentation of an event record in the form of a GUI 400 as displayed on a computing device, in accordance with some implementations. In FIG. 4, user interface 400 includes meeting feed 404, feed tab 408, importance ratings tab 412, attendees tab 416, related meetings tab 420, personal rating pane 432, engagement score pane 436, and contact information pane 440. In some implementations, feed tab 408 is the default selected tab when user interface 400 is first displayed to a user. In some implementations, meeting feed 404 is a feed dedicated to updates about the “Business Behind the Cloud” meeting. As such, feed items 428a, 428b, and 428c concern recent updates regarding “Business Behind the Cloud.” In addition, publisher 424 is configured to publish messages, comments, polls, etc. to meeting feed 404.

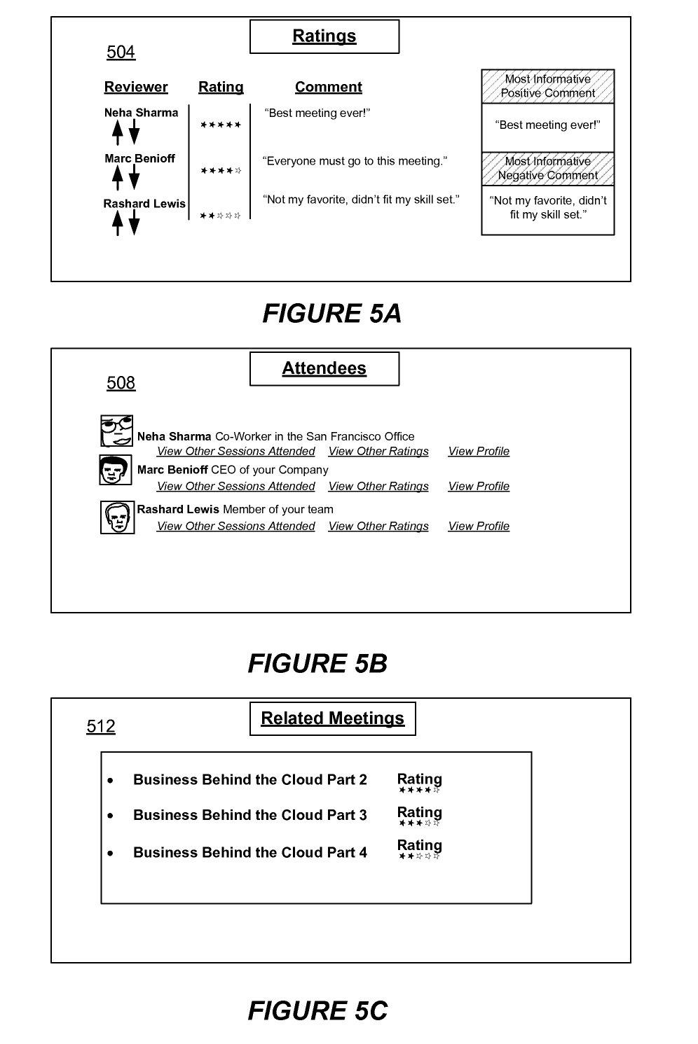

In some implementations, a user can select tabs 412, 416, and 420 to refresh user interface 400 with additional detailed information about “Business Behind the Cloud.” For example, FIGS. 5A-C show other examples of presentations of event records in the form of GUIs 504, 508 and 512 as displayed on a computing device, in accordance with some implementations. In some implementations, a user selecting importance ratings tab 412 of FIG. 4 may be presented with user interface 504 of FIG. 5A. User interface 504 includes details about the importance ratings of “Business Behind the Cloud.” In some implementations, user interface 504 includes a “Most Informative Positive Comment” and “Most Informative Negative Comment.” In another implementation, a user selecting attendees tab 416 of FIG. 4 may be presented with user interface 508 of FIG. 5B. User interface 508 includes details of people attending the “Business Behind the Cloud” meeting. In some implementations, details about the attendees may be accessible through the following hyperlinks: “View Other Sessions Attended,” “View Other Ratings,” and “View Profile.” In still other implementations, a user selecting related meetings tab 420 of FIG. 4 may be presented with user interface 512 of FIG. 5C. User interface 512 includes related meetings for “Business Behind the Cloud.” In this example, “Business Behind the Cloud” is part one of a four part series of meetings. In another non-limiting example, related meetings for “Business Behind the Cloud” can be displayed as a pane in user interface 300 of FIG. 3.

Returning to FIG. 3, below meeting title 320 Lupito sees description 324, which describes the “Influential Skills” meeting as “A lecture from Joe on how to develop influential skills.” Lupito happens to be interested in learning how to develop influential skills; however, he does not know Joe and whether Joe is good instructor. Consequently, Lupito's attention shifts to importance rating 328 to further gauge his interest. In this example, importance rating 328 is an interactive graphical representation of an aggregated average of past attendees' ratings of the “Influential Skills” meeting. Importance rating 328 has a 4 out of 5 stars rating, which indicates that, overall, past attendees found “Influential Skills” useful and that Lupito is likely to find “Influential Skills” useful.

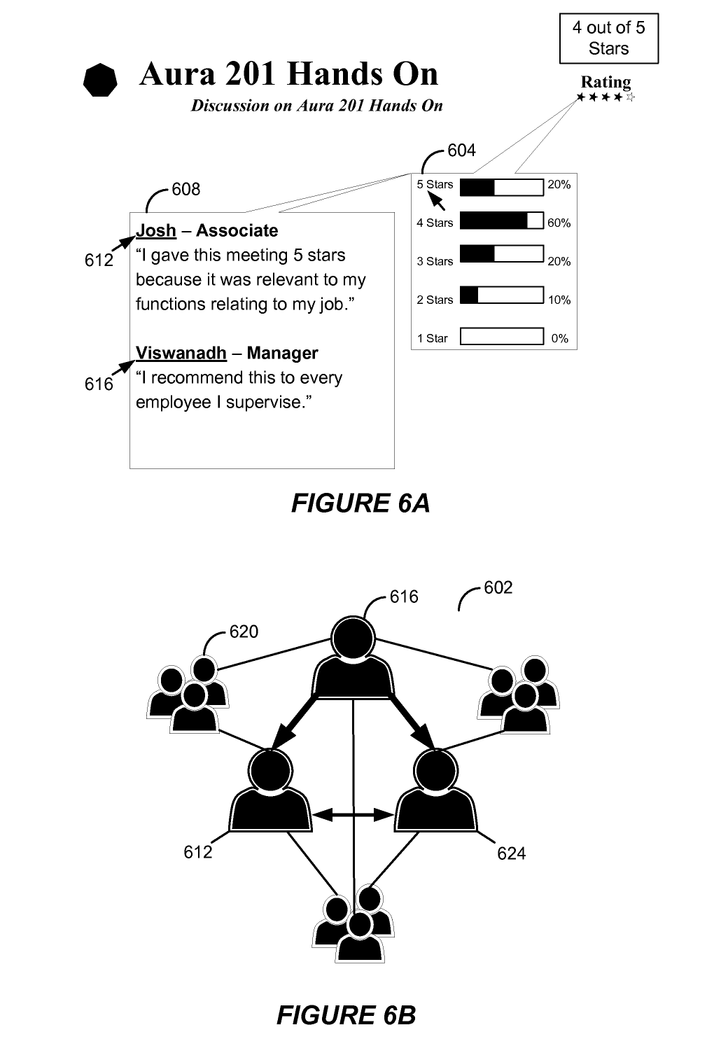

Returning to FIG. 2, in block 216, user input is received and processed by social network server 104 of FIG. 1. In some implementations, user input is generated at an interactive graphical representation such as importance rating 328 of FIG. 3. For example, a user selects the 5^{th} star in importance rating 328, which may be processed by social network server 104 of FIG. 1. Also or alternatively, a user may select “Rating” of importance rating 328, causing a pop-up window with additional information to be displayed in user interface 300. To illustrate, FIGS. 6A-B show examples of team members interacting with an event record, in accordance with some implementations. In FIG. 6A, a user is presented with a detailed importance rating window 604 and user reviews window 608. In some implementations, user reviews window 608 is displayed in response to a user clicking on one of the ratings in detailed importance rating window 604. For example, a user may select “5 Stars” to view the 5 star user ratings in user reviews window 608.

In some implementations, after user input is successfully processed by social network server 104 of FIG. 1, the star selected by the user changes colors indicating that the importance rating represents the user's actual interest. Also or alternatively, the user's selection may persist across presentations of the importance rating. For example, importance rating 328 of FIG. 3 may initially display 4 filled in stars. However, if a user selects the 5^{th} star, importance rating 328 would update to display 5 filled in stars of a different color. In this way, a user could ascertain which meetings he had attended and had selected ratings. In another example, recent importance ratings pane 332 can display a user's most recent importance rating meeting. For example, in FIG. 3, importance rating pane 332 shows that the user's most recent importance rating is a 4-star rating for “Influential Skills.” In some implementations, importance rating pane 332 includes a list of a user's recent importance ratings. In addition, the list of importance ratings may be displayed chronologically in some implementations.

In block 220 of FIG. 2, an aggregate importance rating is updated. In some implementations, the user input indicating a new importance rating of block 216 is added to an aggregate importance rating. Further, the aggregate importance rating can be updated based on an average of the new importance rating combined with previous importance ratings. In one example, an aggregate importance rating for the “Influential Skills” meeting is 3.8. The aggregate importance rating is based on a set of previously processed ratings: 5, 4, 4, 1, and 5. Subsequently, social network server 104 processes a new importance rating of 5 associated with the “Influential Skills” meeting. In this case, the updated aggregate importance rating is 4 based on the new set of processed ratings.

In some implementations, an aggregate importance rating can be adjusted by an engagement score. The engagement score can adjust the aggregate importance rating based on user interactions in relation to one or more factors of the engagement score. For example, user interactions include: clicking attend for a meeting, clicking like for a meeting, visiting a webpage of the meeting, and commenting on a meeting. Examples of factors include: a number of users attending, a number of posts relating to a meeting, a number of likes for a meeting, a number of visits to a webpage, and a number of comments for a meeting. To illustrate, “Popular Meeting” has a 50 users attending, 50 likes, 100 visits, and 25 comments, whereas “Unpopular Meeting” has 10 users attending, 10 likes, 50 visits, and 5 comments. In this situation, “Popular Meeting” may have an engagement score that adjusts its aggregate importance rating upwards and “Unpopular Meeting” may have an engagement score that adjusts its aggregate importance rating downwards. In some implementations, a webpage of a meeting includes a graphical representation of an engagement score. For example, in FIG. 4, engagement score pane 436 includes “381 visits,” “202 comments received,” and “170 likes.” In addition, engagement score pane 436 can include an indicator such as a dot on a scale that indicates the relative engagement of the meeting in relation to all other meetings.

In block 224 of FIG. 2, an updated aggregate importance rating is displayed in a user device (e.g. user system 108b of FIG. 1) different from the user device of block 212 of FIG. 2. In some implementations, the updated aggregate importance rating is displayed along with a new feed item in the feed displayed in user system 108b of FIG. 1. In some but not all implementations, a new feed item is also displayed in the feed of user system 108a.

In block 228 of FIG. 2, a team associated with a user (e.g. user system 108a of FIG. 1) can be identified. In one example, a user may belong to a team such as a “Design Team.” Also or alternatively, a user may belong to more than one team, for instance, “Design Team for Product Alpha” and “Design Team for Product Beta.” In some implementations, a team associated with a user may be identified by social network server 104 of FIG. 1 querying a user's profile stored in social network database 120 and identifying a record indicating team(s) associated with the user. In some implementations, the identified information is temporarily stored in a cache or any other volatile source for use in block 236 discussed below. In block 232 of FIG. 2, a team associated with a second user (e.g. user system 108b of FIG. 1) can be identified in a similar manner to block 228.

In block 236 of FIG. 2, a common team between the users can be determined. In some implementations, the team identified in block 228 and 236 are identical. In some implementations, when social network server 104 of FIG. 1 compares the identified teams of blocks 228 and 236 of FIG. 2 and the compared teams are identical, social network server 104 of FIG. 1 can determine that a common team between the users exists. In some implementations, a record of this common team is stored for future adjusting and/or updating of aggregate importance scores.

In FIGS. 6A and 6B, Josh and Viswanadh are both associated with Design Team Alpha. In this example, Josh is team member 612, Viswanadh is team member 616, and Design Team Alpha is team 620. In some implementations, a team is organized according to discrete levels of an organizational hierarchy. Moreover, at particular levels of the organizational hierarchy, members have the same social role such as associate, manager, etc. For example, team members 612 and 624 are on the same level of organizational hierarchy 602, whereas team member 616 is on a level above team members 612 and 624. The social role of team members on the level of team members 612 and 624 can be “associate” and the social role of team members on the level of team member 624 can be “manager.” In some implementations, a social role includes corresponding job responsibilities. For example, team member 616 is responsible for supervising the work of team members 612 and 624. Further, team members 612 and 624 are responsible for creating new designs. Also or alternatively, team member 612 and 616 are team members of team 620, but team member 624 is not a member of team 620.

In another example, Lupito, a team member of Design Team Alpha, clicks “5 stars” of detailed importance rating window 604. Lupito is presented with user reviews window 608, which displays the reviews of team members 612 and 616, Josh and Viswanadh respectively. In addition, user reviews window 608 displays Lupito's organizational relationship with Josh (associate) and Viswanadh (manager). Also or alternatively, an aggregate importance rating displayed to Lupito may be adjusted based on importance ratings that were from Lupito's team members. For example, the aggregate importance rating may be adjusted higher for ratings from associates on Lupito's team and adjusted even higher for ratings from Lupito's manager.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM record, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

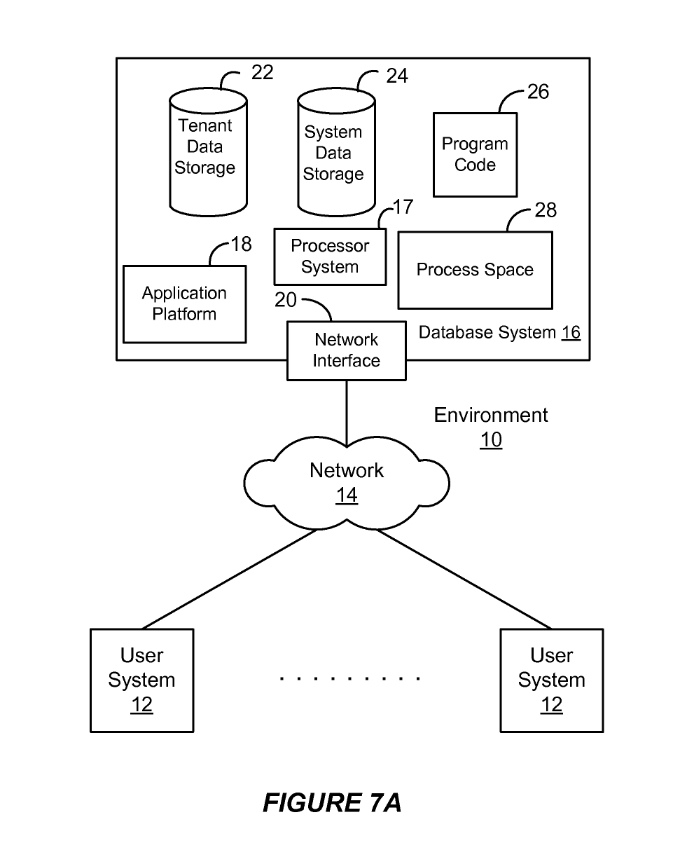

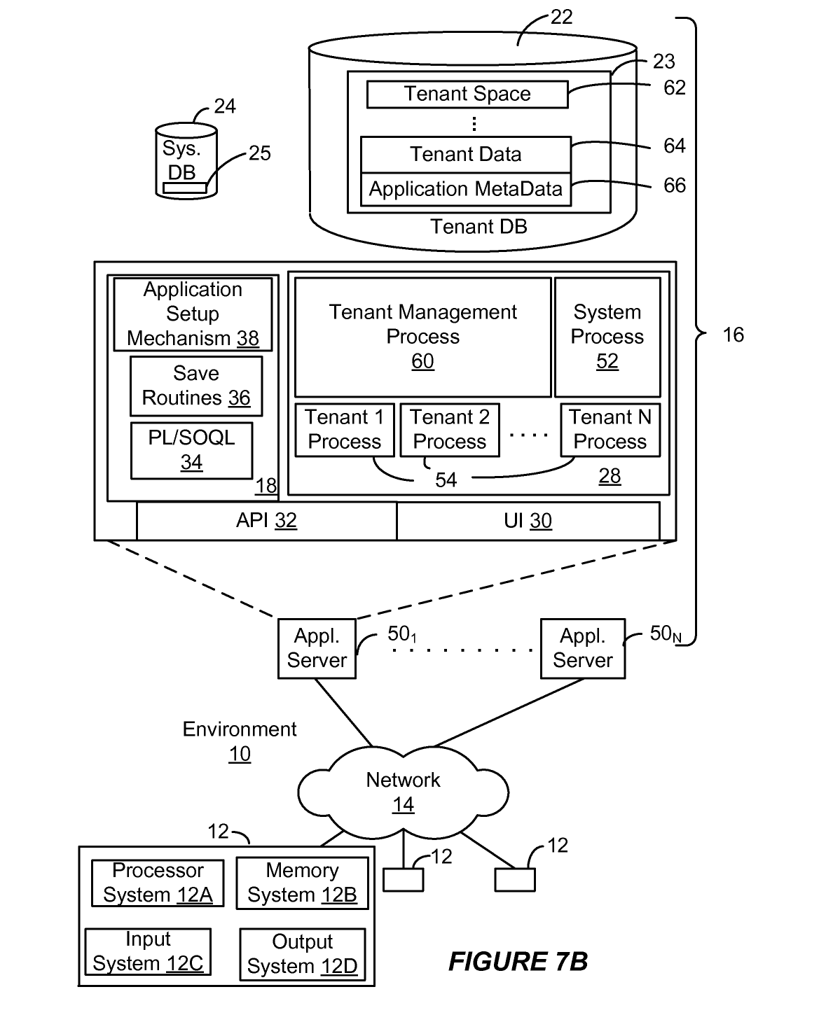

FIG. 7A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 7A (and in more detail in FIG. 7B) user systems 12 might interact via a network 14 with an on-demand database service, which is implemented in the example of FIG. 7A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 7A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 7A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 7B shows a block diagram of an example of some implementations of elements of FIG. 7A and various possible interconnections between these elements.

That is, FIG. 7B also illustrates environment 10. However, in FIG. 7B elements of system 16 and various interconnections in some implementations are further illustrated. FIG. 7B shows that user system 12 may include processor system 12A, memory system 12B, input system 12C, and output system 12D. FIG. 7B shows network 14 and system 16. FIG. 7B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 7A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 7B, system 16 may include a network interface 20 (of FIG. 7A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N}-₁ might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

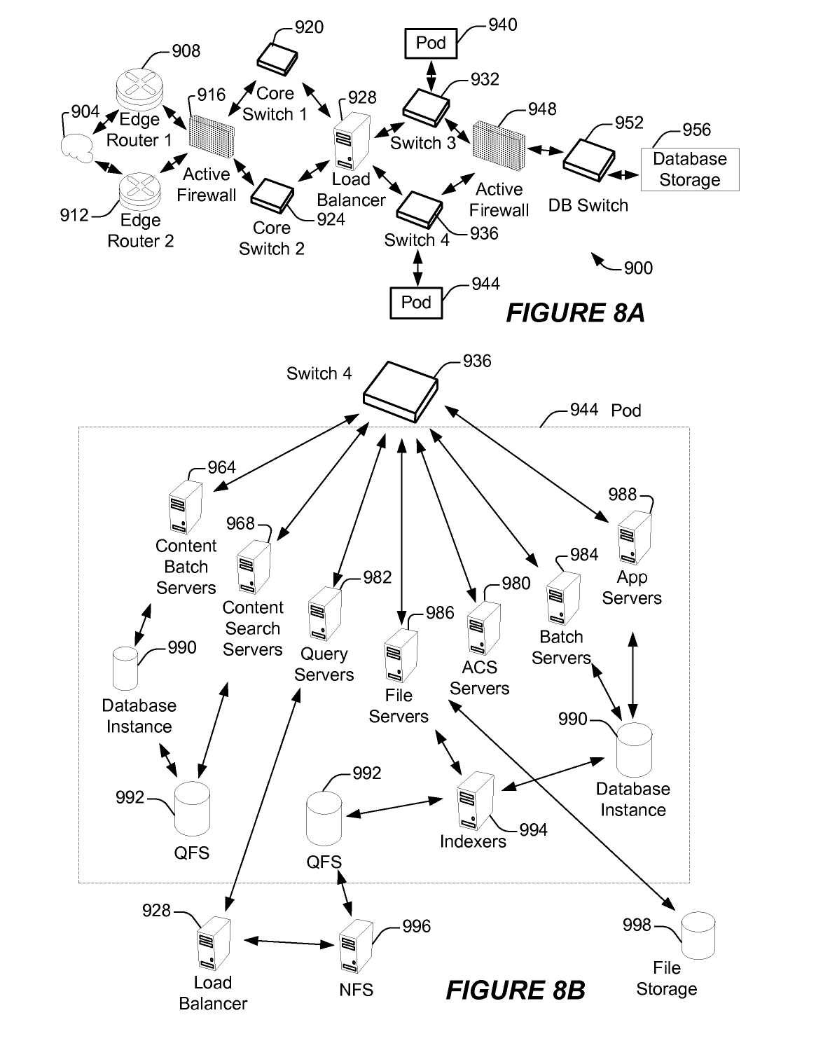

FIG. 8A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 8A and 8B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 8A and 8B, some implementations of an on-demand database service environment may include anywhere from one to many devices of each type. Also, the on-demand database service environment need not include each device shown in FIGS. 8A and 8B, or may include additional devices not shown in FIGS. 8A and 8B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 8B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 8A and 8B.

FIG. 8B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

Some but not all of the techniques described or referenced herein are implemented as part of or in conjunction with a social networking database system, also referred to herein as a social networking system or as a social network. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, Linkedln®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail herein.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a GUI on a display device such as the display of a computing device as described herein. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail herein, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media messages submitted by a user or can otherwise be generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned herein, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media message, such as a user-generated post of text data, and a feed tracked update to a record or profile, such as a change to a field of the record. Feed tracked updates are described in greater detail herein. A feed can be a combination of social media messages and feed tracked updates. Social media messages include text created by a user, and may include other data as well. Examples of social media messages include posts, user status updates, and comments. Social media messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system configurable to:
maintain at least one database storing a plurality of event records, a first one of the event records comprising data related to a meeting associated with an identifiable topic, the data comprising a plurality of importance ratings, each importance rating indicating an importance to a respective one of a plurality of users regarding at least one of: the meeting or the topic;
implement a social networking system comprising a plurality of feeds, at least one of the feeds configurable to publish feed items related to the first event record;
cause, by a server of the database system, display of a first feed item related to the first event record in the at least one feed in a first user interface on a first device of a first user, the displayed first feed item comprising an interactive graphical representation of an aggregate of the importance ratings;
process, by a server of the database system, user input generated via the interactive graphical representation, the user input indicating a first importance rating by the first user regarding at least one of: the meeting or the topic;
update, by a server of the database system, the aggregate importance rating to incorporate the first importance rating; and
cause, by a server of the database system, display of the updated aggregate importance rating in a second user interface on a second device of a second user.

2. The database system of claim 1, the database system further configurable to:
identify, by a server of the database system, a first team associated with the first user;
identify, by a server of the database system, a second team associated with the second user; and
determine, by a server of the database system, that the first user and the second user are members of a common team, the determination based on the identified first team and the identified second team, the common team being organized according to a plurality of levels in an organizational hierarchy with at least a first plurality of members of the common team being on a same level of the organizational hierarchy and at least a second plurality of members of the common team being on different levels of the organizational hierarchy, each member of the common team having a social role corresponding to one or more respective job responsibilities.

3. The database system of claim 1, the database system further configurable to:
cause, by a server of the database system, display of a second feed item related to the first event record in a second feed in the second user interface on the second device of the second user, the displayed second feed item comprising a second interactive graphical representation of the updated aggregate importance rating.

4. The database system of claim 3, the database system further configurable to:
process, by a server of the database system, second user input generated via the second interactive graphical representation, the second user input indicating a second importance rating by the second user regarding at least one of: the meeting or the topic; and
update, by a server of the database system, the updated aggregate importance rating to incorporate the second importance rating.

5. The database system of claim 1, the database system further configurable to:
determine, by a server of the database system, that a first event record is associated with one or more related event records, the determination based at least in part on the second user previously accessing the one or more related event records; and
responsive to the determination, cause, by a server of the database system, display of a second feed item associated with the one or more related event records in the first user interface on the first device of the first user.

6. The database system of claim 1, wherein:
the aggregate importance rating represents a predicted interest of the first user in the first event record, and
the first importance rating represents an actual interest of the first user in the first event record.

7. The database system of claim 1, wherein the first event record further comprises contextual data comprising at least a time, a location, and a list of attending users.

8. The database system of claim 1, wherein the first event record further comprises an engagement score representing a plurality of user interactions with the first event record, the engagement score capable of being processed to adjust the aggregate importance rating based on the user interactions in relation to one or more factors of the engagement score, the one or more factors comprising at least one of: a number of users attending the first event record, a number of comments received, a number of posts, a number of likes received, or a number of user visits to the first event record.

9. A method comprising:
maintaining, by a database system, at least one database storing a plurality of event records, a first one of the event records comprising data related to a meeting associated with an identifiable topic, the data comprising a plurality of importance ratings, each importance rating indicating an importance to a respective one of a plurality of users regarding at least one of: the meeting or the topic;
implementing, using the database system, a social networking system comprising a plurality of feeds, at least one of the feeds configurable to publish feed items related to the first event record;
causing, by a server of the database system, display of a first feed item related to the first event record in the at least one feed in a first user interface on a first device of a first user, the displayed first feed item comprising an interactive graphical representation of an aggregate of the importance ratings;
processing, by a server of the database system, user input generated via the interactive graphical representation, the user input indicating a first importance rating by the first user regarding at least one of: the meeting or the topic;
updating, by a server of the database system, the aggregate importance rating to incorporate the first importance rating; and
causing, by a server of the database system, display of the updated aggregate importance rating in a second user interface on a second device of a second user.

10. The method of claim 9, further comprising:
identifying, by a server of the database system, a first team associated with the first user;
identifying, by a server of the database system, a second team associated with the second user; and
determining, by a server of the database system, that the first user and the second user are members of a common team, the determination based on the identified first team and the identified second team, the common team being organized according to a plurality of levels in an organizational hierarchy with at least a first plurality of members of the common team being on a same level of the organizational hierarchy and at least a second plurality of members of the common team being on different levels of the organizational hierarchy, each member of the common team having a social role corresponding to one or more respective job responsibilities.

11. The method of claim 9, further comprising:
causing, by a server of the database system, display of a second feed item related to the first event record in a second feed in the second user interface on the second device of the second user, the displayed second feed item comprising a second interactive graphical representation of the updated aggregate importance rating.

12. The method of claim 11, further comprising:
processing, by a server of the database system, second user input generated via the second interactive graphical representation, the second user input indicating a second importance rating by the second user regarding at least one of: the meeting or the topic; and
updating, by a server of the database system, the updated aggregate importance rating to incorporate the second importance rating.

13. A computer program product comprising computer-readable program code to be executed by one or more processors when retrieved from a non-transitory computer-readable medium, the program code including instructions configured to cause:
maintaining, by a database system, at least one database storing a plurality of event records, a first one of the event records comprising data related to a meeting associated with an identifiable topic, the data comprising a plurality of importance ratings, each importance rating indicating an importance to a respective one of a plurality of users regarding at least one of: the meeting or the topic;
implementing, using the database system, a social networking system comprising a plurality of feeds, at least one of the feeds configurable to publish feed items related to the first event record;
displaying a first feed item related to the first event record in the at least one feed in a first user interface on a first device of a first user, the displayed first feed item comprising an interactive graphical representation of an aggregate of the importance ratings;
processing, by a server of the database system, user input generated via the interactive graphical representation, the user input indicating a first importance rating by the first user regarding at least one of: the meeting or the topic;
updating, by a server of the database system, the aggregate importance rating to incorporate the first importance rating; and
displaying the updated aggregate importance rating in a second user interface on a second device of a second user.

14. The computer program product of claim 13, the instructions further configured to cause:
identifying, by a server of the database system, a first team associated with the first user;
identifying, by a server of the database system, a second team associated with the second user; and
determining, by a server of the database system, that the first user and the second user are members of a common team, the determination based on the identified first team and the identified second team, the common team being organized according to a plurality of levels in an organizational hierarchy with at least a first plurality of members of the common team being on a same level of the organizational hierarchy and at least a second plurality of members of the common team being on different levels of the organizational hierarchy, each member of the common team having a social role corresponding to one or more respective job responsibilities.

15. The computer program product of claim 13, the instructions further configured to cause:
displaying a second feed item related to the first event record in a second feed in the second user interface on the second device of the second user, the displayed second feed item comprising a second interactive graphical representation of the updated aggregate importance rating.

16. The computer program product of claim 15, the instructions further configured to cause:
processing, by a server of the database system, second user input generated via the second interactive graphical representation, the second user input indicating a second importance rating by the second user regarding at least one of: the meeting or the topic; and
updating, by a server of the database system, the updated aggregate importance rating to incorporate the second importance rating.

17. The computer program product of claim 13, the instructions further configured to cause:
determining, by a server of the database system, that a first event record is associated with one or more related event records, the determination based at least in part on the second user previously accessing the one or more related event records; and
responsive to the determination, displaying a second feed item associated with the first related event record in the first user interface on the first device of the first user.

18. The computer program product of claim 13, wherein:
the aggregate importance rating represents a predicted interest of the first user in the first event record, and
the first importance rating represents an actual interest of the first user in the first event record.

19. The computer program product of claim 13, wherein the first event record further comprises contextual data comprising at least a time, a location, and a list of attending users.

20. The computer program product of claim 13, wherein the first event record further comprises an engagement score representing a plurality of user interactions with the first event record, the engagement score capable of being processed to adjust the aggregate importance rating based on the user interactions in relation to one or more factors of the engagement score, the one or more factors comprising at least one of: a number of users attending the first event record, a number of comments received, a number of posts, a number of likes received, or a number of user visits to the first event record.
